(19) United States
(12) Patent Application Publication
(10) Pub. No.: US 2007/0148612 A1
(43) Pub. Date: Jun. 28, 2007

(54) DENTAL IMPRESSION TRAY AND METHOD

(75) Inventor: Joseph J. Massad, Tulsa, OK (US)

Correspondence Address: HEAD, JOHNSON & KACHIGIAN, 228 W 17TH PLACE, TULSA, OK, 74119, US

(73) Assignee: GLOBAL DENTAL IMPRESSION TRAYS, INC., Tulsa, OK (US)

(21) Appl. No.: 11/680,992

(22) Filed: Mar. 1, 2007

Related U.S. Application Data
(63) Continuation-in-part of application No. 11/393,560, filed on Mar. 30, 2006.
(60) Provisional application No. 60/780,133, filed on Mar. 8, 2006.
(60) Provisional application No. 60/667,632, filed on Apr. 2, 2005.

(51) Int. Cl. A61C 9/00

(52) U.S. Cl. 433/37

(57) ABSTRACT

A dental impression tray used in cooperation with at least one impression material for obtaining an impression of a jaw, teeth and gingiva area in an oral cavity of a dentate or dental prosthesis patient and a method of use thereof. The dental impression tray comprises a body, a plurality of body openings, and a means of insertion and removal of the dental impression tray. The body is formed by an outer support section, a channel section and a central support section. The means for insertion and removal of the dental impression tray generally comprises a shelf section, a border and a handle section. The shelf section is attached to the body of the dental impression tray and serves to displace the pressure exerted upon the shelf section uniformly along the shelf section and onto the body. The border provides more surface area to improve retention of the impression material on the dental impression tray and to reduce the pressure against the jaw, teeth and gingiva areas. The plurality of body openings are positioned throughout the body to allow the impression material to vent through the body openings to obtain the impression and to retain the impression material onto the body.

### CROSS-REFERENCE TO RELATED APPLICATIONS

This application claims priority to U.S. Provisional Application No. 60/780,133, filed Mar. 8,2006, and is a continuation-in-part of U.S. application Ser. No. 11/393,560, filed Mar. 30, 2006, which claims priority to U.S. Provisional Application No. 60/667.632, filed Apr. 2, 2005.

### BACKGROUND OF THE INVENTION

1. Field of the Invention

The present invention relates to a novel dental impression tray for obtaining accurate impressions of the jaw, teeth, and gingiva area of dentate patients; or the jaw, implants and gingiva area of patients with dental implants or prosthesis (i.e. artificial teeth). The present invention also relates to a novel method for obtaining an impression of the jaw, teeth and gingiva area to the oral cavity of a dentate or dental prosthesis patient that is both accurate and repeatable when used with the novel dental impression tray disclosed herein.

2. Prior Art

In dentistry, an impression is often used to create an imprinted likeness of the jaw, teeth or implants, if they exist (herein the term “teeth” shall be intended to include teeth; implants (i.e. artificial teeth); or the combination of teeth and implants), and gingiva areas of the oral cavity or, more specifically, the oral cavity of a patient in preparation for the restoration of dental structure, such as complete or partial dentures or dental prosthesis (hereinafter referred to as “dental devices”). The ability of the dental technician or dentist to obtain a satisfactory impression is influenced by the dental impression tray (hereinafter called “dental tray” or “dental impression tray”); the selection of the moldable materials (hereinafter called “impression materials”) to be used with the dental tray; and the procedure or method that the dental technician or dentist uses to obtain the impression.

The accuracy of the impression, to a large extent, will depend upon hoe well the dental tray is received in a patient's oral cavity. In order to gain an accurate impression, numerous types of dental trays have been developed. Some dental trays are designed for numerous applications and are called standard trays. Some dental trays are specifically designed for a single purpose, such as a dental tray designed for only one side of a patient's oral cavity. Some dental trays are designed for use with only a dentate or an implant patient, which are patients that still have at least some of their teeth or have implants in place of teeth, as disclosed in U.S. Pat. No. 6,457,973, issued on Oct. 1, 2002 to Johann Fetz. Some dental trays are adjustable to allow one dental tray to fit a large number of patients, as disclosed in U.S. Pat. No. 6,428,315, issued on Aug. 6, 2002 to David M. Prestipino. Some dental trays are designed to allow impression material to be placed in the patient's oral cavity through the dental tray after inserting the tray in the patient's oral cavity, as disclosed in U.S. Pat. No. 6,641,393, issued on Nov. 4, 2003 to Konstantine Trichas. Some dental trays, called enhanced trays, are larger devices that help lift the patient's tongue up and away from the jaw and gingiva areas to assist with obtaining an impression of edentulous patients. All of the above referenced dental trays are intended to be reused. Therefore, they are made from metal and sometimes have plating, such as chrome or stainless steel, which makes them very expensive to manufacture. This makes these dental trays very expensive for a dentist to purchase and then the dentist has the additional expense of cleaning and sterilizing them before they can be reused.

When each of the different trays in the prior art do address certain problems with obtaining accurate impressions, they also create new problems or do not work well with all types of impression material. One problem is that the prior art causes excessive impression material to be expelled backward into the throat of the patient causing discomfort and sometimes gagging. Another problem is that the prior art are not build to match the anatomy of the patient's jaw, teeth and gingiva of the oral cavity. This can lead to the dental tray deforming the patient's jaw and gingiva areas, thus preventing an accurate impression. This also leads to having to use excessive impression material, which most often leads to a low quality impression and contributes to a patient's discomfort and gagging. Yet another problem is that the prior art does not work well with the entire range of impression materials, from extra light to very heavy in density, due to openings in the dental trays having either small openings or large openings. Where the dental tray has small openings, it does not distribute the medium to very heavy density impression materials well. Where the dental tray has large openings, it does not contain the extra light to medium density impression well. This causes the dental technician or dentist to use impression materials that work with the dental tray while another type of impression material would provide better results, i.e., the type of impression material used is dependent upon the type of dental tray used by the dental technician or dentist. Yet another problem is that the prior art does not provide a means for uniformly distributing pressure to the dental tray to ergonomically seat the dental tray and impression material in the patient'oral cavity. When inserting the dental tray and impression material in the patient's oral cavity, the dental technician or dentist must push on the tray to seat it around the jaw, teeth or implants, and gingiva areas. Since the prior art does not provide a way to distribute this pressure uniformly, the dental tray will seat deeper at the point where the pressure is applied, thus creating an inaccurate impression. Still yet another problem is removal of the dental tray and impression material after the impression material has cured, which can be a difficult task and the impression can be altered or damaged during the removal effort. The prior art does not provide any means to assist with the removal of the dental tray and cured impression material. Yet another problem is that the dental trays of the prior art are made from metal or are plated with metal, such as chrome or stainless steel, which is suitable for use in the patient's oral cavity. This makes these dental trays expensive to purchase and costly to reuse due to the cost of cleaning and sterilizing after each use.

The impression material used in conjunction with the dental tray also affects the accuracy of the impression. Depending on the impression material used, the cured impression may be hard or have some elastic characteristics, also referred to as semi-hard. Impression materials must set or cure rapidly in order to obtain the desired impression of the patient's oral cavity. If the impression material sets up or cures to a very hard state, such as plaster, the impression material will tend to distort the patient'oral cavity and not provide an accurate impression. If the impression material sets up or cures to a semi-hard state, the impression may not hold its shape during the process of creating the dental structure. Such impression materials, like silicone, have flow streaks or voids that appear in the cured material in the transitional area between the patient's gingiva and the tray. These voids are caused by the flow properties of the impression material when the tray filled with the impression material is fitted to the jaw. These voids will cause an inaccurate impression so that the subsequent work on such sites by the dental technician, which is important for fitting a dental device to the patient, will be made with insufficient precision thereby increasing the labor of the dental technician and/or the dentist, or in more severe cases causing the entire mold to become useless.

Even if the correct tray is selected and the best impression material is selected, the accuracy of the impression of the patient's oral cavity depends upon the method employed by the dental technician or dentist to obtain the impression. Patient methods of obtaining the impression with a dental tray and impression material fail to create an accurate impression of the jaw, teeth, if they exist, and gingiva areas of the oral cavity of the patient. Typical methods of making impression consist of: (1) selecting a reusable standard dental tray, this is because the standard dental tray is manufactured to fit the average patient (really meaning the largest number of patients) and this limits the investment in trays that the dentist is required to make as it is reusable; (2) placing a impression material in the dental tray; (3) placing the dental tray; with impression material being retained by the tray, within the oral cavity of the patient; (4) having the patient bite down on the tray to deform the impression material; (5) having the patient hold his bite on the tray until the impression material sets or cures; and (6) removing the tray with the impression material after the impression material is allowed to set or cure. The standard method used by dental technicians and dentists to obtain impressions of the patient's oral cavity actually distorts the patient's Mylohyoid muscles and the Lingual structures, resulting in inaccurate impressions.

Therefore, there is a need in the art for a new dental tray and method that provides repeatable, highly accurate impressions of a patient's jaw, teeth and gingiva area by more closely matching the anatomy of the patient's oral cavity so that the patient's jaw, teeth and gingiva areas are not deformed and so that less impression material is required to obtain an accurate impression which will reduce the discomfort and gagging of the patient; by allowing the use of the entire range of impression materials so that the best impression materials can be used to obtain the impression; by providing a means to transfer pressure uniformly to the dental tray so that the impression material is ergonomically seated in the patient's mouth to obtain an accurate impression with less discomfort to the patient; by providing an effective means to assist with the removal of the dental tray after the impression material has cured so as to not damage the impression; by providing a dental tray that is intended for a single use; and by providing a dental tray that is inexpensive to manufacture and sell.

It is therefore desirable to develop a novel dental tray for making an impression of a patient's jaw, teeth, if they exist, and gingiva areas in oral cavity in cooperation with an impression material, where the dental tray's overall shape more matches the anatomy of the patient's jaw, teeth and gingiva area so that less impression material will be required to obtain a high quality impression of the patient's jaw, teeth and gingiva area.

It is also desirable to develop a new dental tray for obtaining impressions of the patient's jaw, teeth and gingiva area of the oral cavity that can be used with the entire range of impression materials from extra light to very heavy in density.

It is also desirable to develop a novel means for inserting the dental tray that uniformly transfers pressure applied by the dental technician or dentist to the dental tray so that the impression material is ergonomically seated in the oral cavity to obtain an accurate impression while reducing the discomfort to the patient.

It is also desirable to develop a new means for removal of the dental tray that provides a way for the dentist or dental technician to remove the dental tray and cured impression material from the oral cavity that prevents damage to the impression while reducing the discomfort to the patient.

It is also desirable to provide a new dental tray that can be made from non-metal material that is inexpensive to manufacture and sell. This will allow the dental tray to be cost effective as a single use product that is discarded after its initial use. This will also reduce the dentist's costs of operations by eliminating the need to repeatedly clean and re-sterilize dental trays.

It is also desirable to provide a new method for obtaining an impression of the patient's jaw, teeth and gingiva area of the oral cavity that is very accurate each and every time the new method is used with the new dental tray.

### SUMMARY OF THE INVENTION

The embodiments of the present invention are directed to an improved dental tray for obtaining accurate impressions of the jaw, teeth and gingiva area of the oral cavity of dentate, implant or dental prosthesis patient. The embodiments of the present invention are directed to an improved dental tray comprising a body and a means for inserting and removal of the dental tray, wherein the dental tray is made either metal; or made from metal and then placed with metal such as chrome or stainless steel; or made from non-metal materials that are suitable for use in the patient's oral cavity. The dental tray of the present invention is desired to have an anatomical shape to accommodate most anatomical features presented by these patients. The dental tray will act as a carrier to retain varying impression materials distributed in the dental profession. A plurality of body openings allow the impression material to flow with the least resistance while acting to retain the impression materials during curing to prevent distortion or movement to allow an accurate cast to be made of the patient's jaw, teeth and gingiva area. A border of the body of the dental tray allows the impression material to capture anatomical features of patient with the minimum amount of impression material. The development of a shelf section allows ergonomic seating of the dental tray in the patient's mouth and easy removal of the dental tray after impression material cures. The dental trays are to be made in a various sizes to accommodate the highest percentage of the population. The dental tray of the present invention is shaped to closely match the anatomy of a patient's oral cavity, has a border that allows the dental tray to capture the anatomy of the patient's oral cavity at this critical point with the least amount of impression material, uses a combination of different shaped openings in the body of the tray, uses a shelf section to ergonomically seat the dental tray to obtain an accurate impression using the minimum amount of impression materials without restricting the type of impression material that can be used, and uses the shelf section to assist with removal of the dental tray when the impression is cured. The embodiments of the present invention also contemplate a means for insertion and removal of the dental tray at a predetermined location on an exterior portion of the body so as to allow the insertion and removal of the dental tray from the patient's oral cavity when impression material is applied and retained to all area of the body of the dental tray.

In one embodiment of the present invention, the body comprises an outer support section, a channel section, a central support section and a border. The outer support section is connected to the center support section by the channel section. The border is substantially positioned along an edge of the outer support section so that the border is the component of the body that is in the closest proximity to the patient's oral cavity. The combination of the outer support section, the channel section, the central support section and the border cooperate to form the overall structure of the body having a predetermined shape that is substantially similar to the anatomy of the jaw, teeth and gingiva areas of a patient's oral cavity and having a plurality of body openings. The shape of the body being substantially close to the anatomy of the patient's jaw, teeth and gingiva areas allows impressions of these area to be obtained with minimum amount of impression material. It also allows the dental technician or dentist to obtain an impression that does not distort the Mylohyoid muscles and the Lingual structure in the patient's oral cavity. In one embodiment of the present invention, the border is substantially circular or annular in shape having a plurality of border channels. The border channel is substantially a V-shaped cut or notch in the border at predetermined locations on the exterior and interior sides of the border. The border allows for less impression material to be used to capture the anatomical features of the patient's oral cavity at the point where the body is in the closest proximity to the oral cavity, while the plurality of border channels provide additional surface area to retain the thin layer of impression material on the border until it is cured to prevent distortion of the impression material. In an embodiment of the present invention, the plurality of body openings comprise a plurality of dumbbell-shaped body openings of various sizes and at least one circular shaped body opening. The plurality of body openings have predetermined shapes and sizes such that the combination of openings cooperate to allow the impression material to distribute or vent with the least resistance while acting to retain the impression material until it is cured to prevent distortion of the impression material. These features allow the dental tray to successfully use a wide range of impression materials that vary from extra light to very heavy in density.

In one embodiment of the present invention the means for insertion and removal of the dental tray comprises a handle section, a transition section, a shelf section and a means for reinforcement of the shelf section and the outer support section. The handle section is connected to the shelf section by the transition section. The shelf section is substantially a sheet of material having a parabolic or arcuate shape with a flat and a rounded portion. The shelf section is received on the exterior of the body in a predetermined location such that the flat portion of the shelf surface is facing toward the jaw, teeth and gingiva area of the patient's oral cavity while the rounded portion of the shelf surface is facing in a direction that is opposite of the flat portion of the shelf surface. The rounded portion of the shelf surface is specifically located on the body such that any pressure placed upon the rounded portion of the shelf surface will transfer along the length of the shelf section and onto the body uniformly. The flat portion of the shelf surface allows the dental technician or dentist a place to pull down on the dental tray with either their fingers or with a tool to remove the cured impression. This ensures that the impression is never damaged or distorted by the removal process because the pressure to remove the cured impression is transferred uniformly to the body. The means reinforcement of the shelf section and the outer support section is used to provide stability between the means for insertion and removal of tray and the body when impression material is being retained onto the dental tray. In one embodiment of the present invention, the means for reinforcement of the shelf section and the outer support section comprise a reinforcement section that is connected to both the flat portion of the shelf section and the exterior of the outer support section of the body.

To meet another of the objectives of the invention, a novel method of obtaining an impression with the improved dental tray disclosed herein has been developed. Other methods of obtaining an impression using either standard trays or enhanced trays with impression materials fail to provide a truly accurate impression of the patient's oral cavity. As aforementioned, the reason for this failure is that other methods of obtaining impressions of the patient's oral cavity actually distort the Mylohyoid muscles and the Lingual structures in the patient's oral cavity, which produces an impression that is only truly representative of the patient's oral cavity. This inaccurate impression leads to the production of dental devices that fail to match the patient's oral cavity, resulting and sometimes injury to the patient. Other methods of obtaining impressions provide inconsistent result, while sometime the methods of obtaining the impression provide a satisfactory result. Other times the method of obtaining the impression provide a result that is completely unsatisfactory, which requires the impression to be redone. Some methods require a preliminary impression, which is then used to make a final impression, requiring the dental technician or dentist to go through the impression methods steps twice.

The novel method of obtaining an impression with the improved dental tray contemplated by the embodiments of the present invention comprise the following steps: (1) selecting the proper sized new dental tray to be used to obtain the impression; (2) selecting impression material with desired curing properties to be used with the selected new dental tray; (3) applying the impression material to the peripheral of the new dental tray; (4) placing the new dental tray, with the impression material retained by the new tray, in patient's oral cavity with the means for insertion and removal of the tray; (5) having the dentist or dental technician hold the dental tray and impression material in position in the oral cavity which causes the impression material to flow through the plurality of openings in the body such that the impression material transfers to fill in any voids in order to create an impression of the patient's oral cavity while performing functional movements to further deform the uncured impression material; wherein the functional movements include at least one swallowing movement, at least one chewing movement, and at least one tongue movement; (6) holding the dental tray impression material in place until the impression material is cured; (7) removing the dental tray and cured impression materials from the patient's oral cavity with the means for insertion and removal of the tray to prevent damage of the impression; and (8) removing any nonessential impression material from the dental tray.

Other exemplary embodiments and advantages of the present invention may be ascertained by reviewing the present disclosure and the accompanying drawings.

### BRIEF DESCRIPTION OF THE DRAWINGS

FIG. 1 is a top plan view of one embodiment of the present invention.

FIG. 2 is a front view of the embodiment of the present invention shown in FIG. 1.

FIG. 3 is a top perspective view of the embodiment of the present invention shown in FIG. 1.

FIG. 4 is a side view of the embodiment of the present invention shown in FIG. 1.

FIG. 5 is a bottom perspective view of the embodiment of the present invention shown in FIG. 1.

FIG. 6 is a top plan view of another embodiment of the present invention.

FIG. 7 is a front of the embodiment of the present invention shown in FIG. 6.

FIG. 8 is a top perspective of the embodiment of the present invention shown in FIG. 6.

FIG. 9 is a side view of the embodiment of the present invention shown in FIG. 6.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

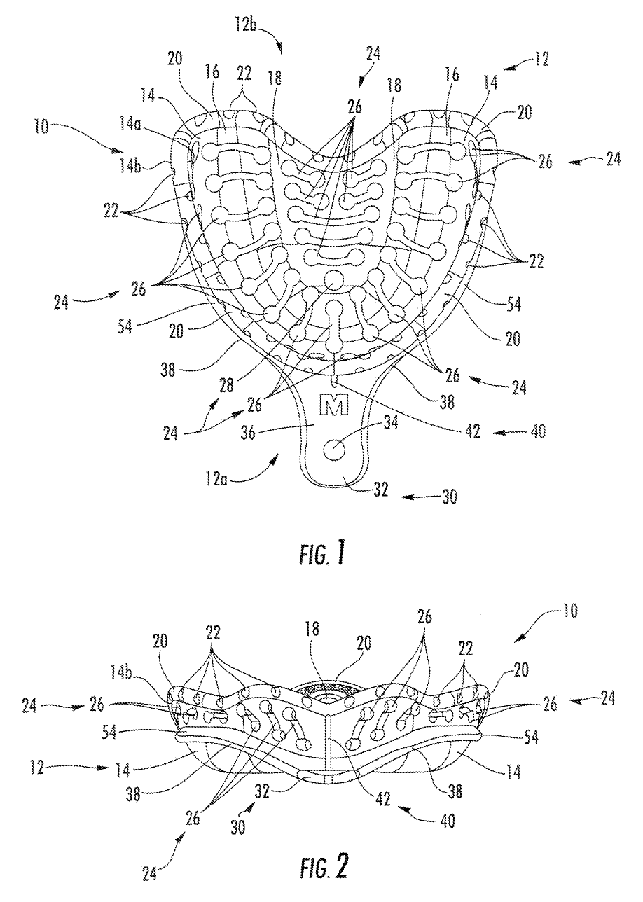

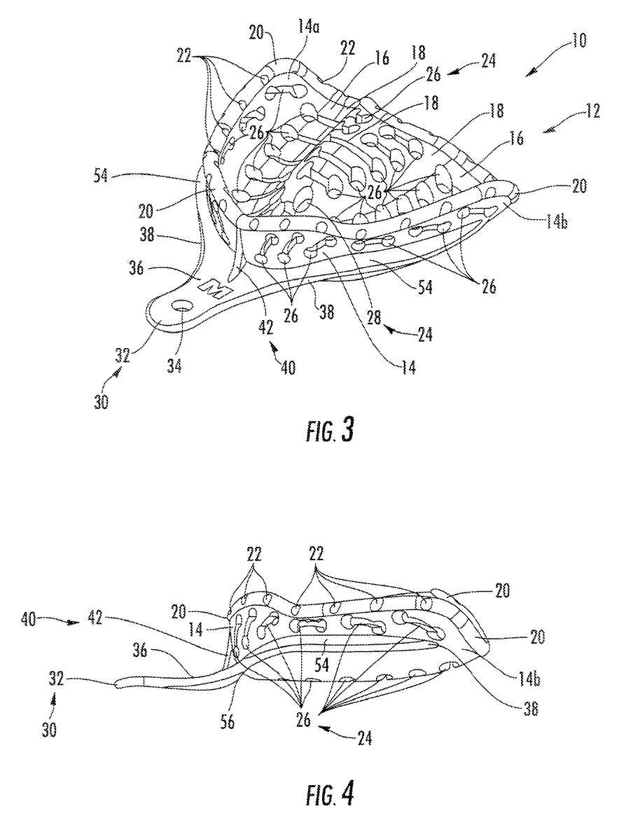

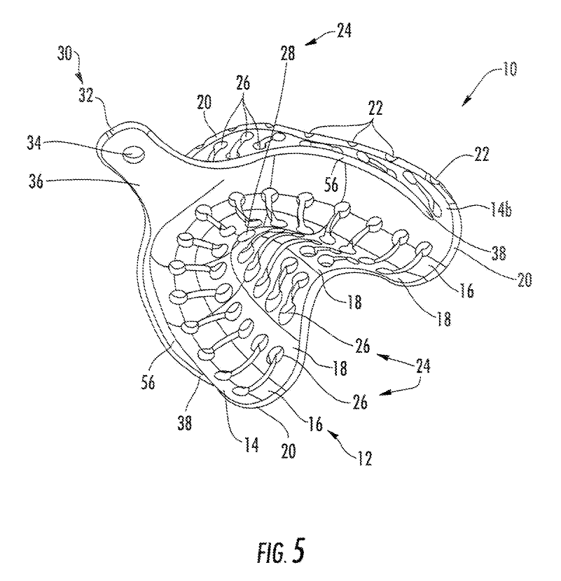

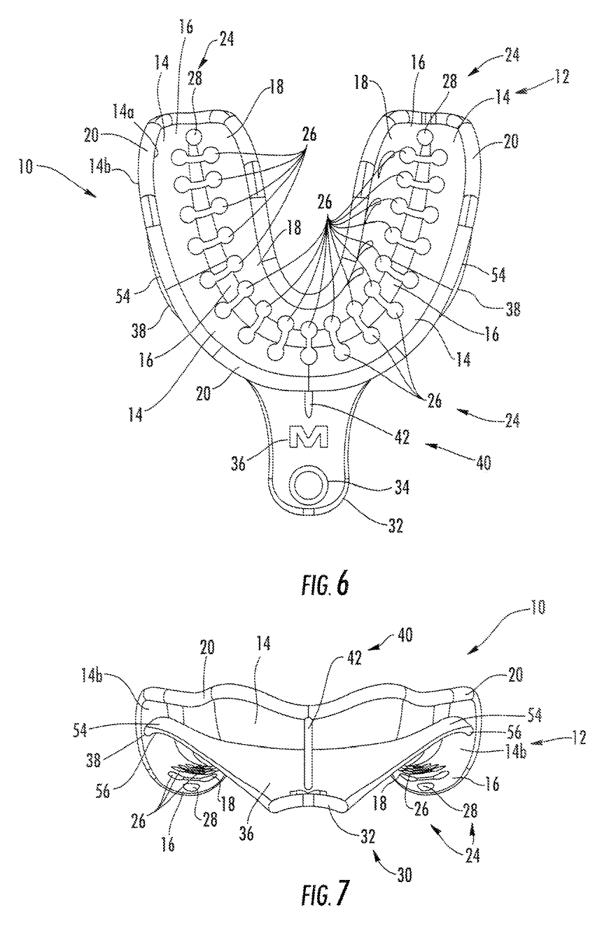

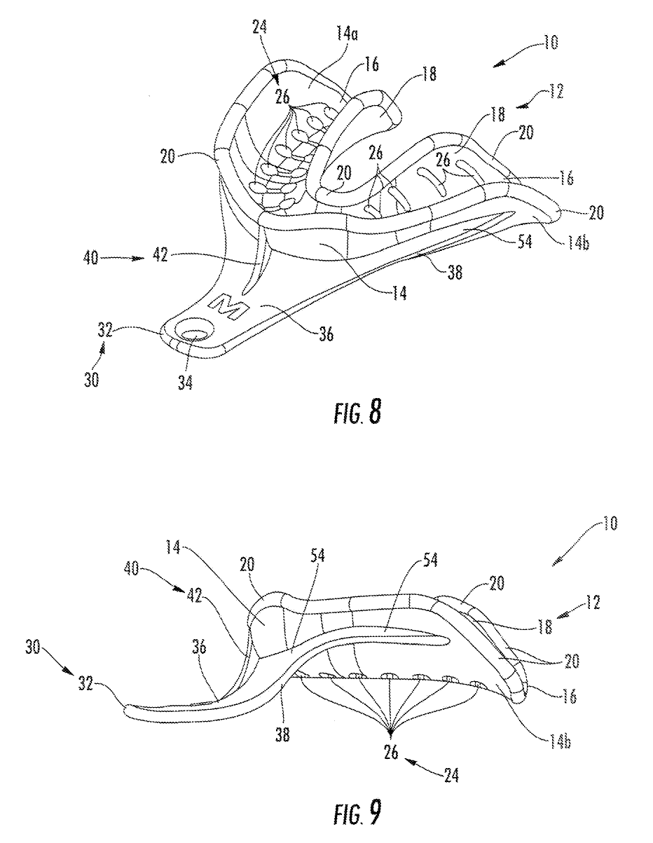

Referring to the figures of the drawings, wherein like numerals of reference designate like elements throughout the several views, particularly to FIG. 1, there is shown a top view of a dental tray 10 to be used in cooperation with at least one impression material for obtaining an impression of the jaw, teeth and gingiva areas of the oral cavity of a dentate or dental prosthesis patient, where the impression material is not shown. One or a combination of impression materials may be used. In addition, the impression material has a density range from extra light to very heavy. As shown in FIGS. 1 through 9, the dental tray 10 comprises a body 12, a shelf section 38, a border 20 and a handle section 32. FIGS. 1 through 5 show one embodiment of the present invention while FIGS. 6 through 9 show another embodiment of the present invention. The predetermined shape of the body 12 accommodates the anatomical shape of the dentate or dental prosthesis patient's oral cavity and is dimensioned and configured to be placed around the entire jaw, teeth and gingiva area while retaining the impression material.

The dental tray 10 can be made from a variety of materials such as metal; metal plated with other material, such as with chrome, stainless steel, a polymer or resin material; or non-metal materials, such as heat moldable plastic material such as polymer or resin. In the preferred embodiment of the invention, the dental tray 10 is made from a thermoplastic polymer material, where the preferred thermoplastic polymer material is polystyrene.

It is desirable to have the body 12 of the dental tray 10 be capable of being locally reshaped by the dentist or dental technician to allow the body 12 to better fit the patient's mouth. Being able to reshaped the body 12 to obtain this clearance is extremely important to obtaining an accurate impression. In the prior art, the body of these dental trays are not reshapeable because they are made from metal or are made from plastic material that cannot be reheated to allow them to be remolded or are made from plastic with a body thickness that is either too thin or too thick to be heated and remolded. The thickness of the body 12 also affects the dentist dental technician's ability to reshape the body 12 by trimming the body 12, where an external cutter, such as a dental bur, accomplishes the trimming. If the body 12 is too thin, then the dentist or dental technician can quickly remove more of the body 12 than they intend to and have to dispose of the dental tray. If the body 12 is too thick, then the dentist or dental technician has to spend a lot of time to take off more material and may fail to remove enough without repeated attempts. Having the body 12 comprised of a heat moldable thermoplastic material, such as polystyrene material, a reasonable thickness could be removed with a dental bur to reshape the body 12.

A body 12 made from moldable plastic material, such as polystyrene, will allow localized reshaped of the body 12: (1) by heating and remolding the body 12, where heating is accomplished with an external heating source such as an open flame, or (2) trimming of the body 12, where trimming is accomplished by an external cutter such as a dental bur, such that the reshaped of the body 12 allows the predetermined shape of the body 12 to be modified to specifically accommodate the patient's jaw, teeth and gingiva areas which prevents deforming the jaw, teeth and gingiva area of the patient's oral cavity when the dental impression tray 10 is used in cooperation with impression materials to obtain an impression.

The body 12 comprises an interior portion 12a, an exterior portion 12b, an outer support section 14 having an interior portion 14a and an exterior portion 14b, a channel section 16, a central support section 18, and a plurality of body openings 24, where the outer support section 14 is connected to the central support section 18 by the channel 16 to form the body 12. The central support section 18 has a substantially curved end at the posterior end 12b of body 12. In one embodiment, the substantially curved end in the central support section 18 is for capturing the hard-soft throat palate of the patient's upper jaw, while in another embodiment the substantially curved end in the central support section 18 accommodates the sublingual gland and fatty tissue of the lower jaw to allow capturing of the Mylohyoid space. When the substantially curved end in the central support section 18 is used for capturing the hard/soft throat palate, it comprises an upwardly contoured palate ledge spanning the outer support section 14.

The plurality of body openings 24 comprises a plurality of substantially dumbbell shaped body openings 26 and a plurality of substantially circular or annular shaped body openings 28. The dumbbell shaped body openings 26 have a variety of sizes and orientations depending on where they are located in the dental tray 10. The annular shaped body opening 28 have a predetermined size as shown in FIGS. 1 through 5 for one embodiment of the present invention and as shown in FIGS. 6 through 9 for another embodiment of the present invention. The dumbbell shaped body openings 26 and the annular shaped body openings 28 are positioned in the outer support section 14, the channel section 16 and the central support section 18 at predetermined locations such that the combination of the size and location of the dumbbell shaped body openings 26 and the annular shaped openings 28 cooperate with the outer support section 14, the channel section 16 and the central support section 18 to: (1) allow the impression material or a combination of impression materials to vent through the dumbbell shaped body openings 26 and the circular shaped body openings 28 to obtain the impression of the jaw, teeth and gingiva area of the patient by providing more openings and by providing larger openings than previous prior art in order to make it easier for the impression material to flow to any void spots that may exist around the jaw, teeth and gingiva areas, and (2) retain the impression material or a combination of impression materials on the outer support section 14, the channel section 16 and the central support section 18 by providing more surface area for the impression material of a combination of impression materials to adhere to without the use of adhesive. In particular, the combination of the dumbbell shaped body openings 26 and the circular shaped body openings 28 are designed to “lock in” the polyvinyl siloxane impression material, making the use of an odorous and distasteful tray adhesive unnecessary.

A border 20 is positioned along a terminal end of the outer support section 14. The border 20 is substantially annular in shape having a plurality of border channels 22. The border 20 has a predetermined diameter such that the diameter of the border 20 is slightly larger that the thickness of the body 12 to provide more surface area to improve retention of the impression material on this part of the dental tray 10 and to reduce the pressure against the jaw, teeth and gingiva area. The border 20 is designed to capture the full extent of the dentate ridge and surrounding anatomy without exerting unwanted pressure while retaining the impression material on the body 12. Border channels 22 comprise substantially V-shaped cuts or notches. The plurality of border channels 22 are positioned perpendicular to the border 20 at predetermined locations on the exterior and interior of the border 20 such that the plurality of border channels 22 cooperate with the border 20 and the impression material to retain the impression material on the body 12 by providing additional surface area to retain the layer of impression material on the border 20.

The dental tray 10 further comprises a means for insertion and removal 30 of the dental tray 10 comprising a handle section 32, a transition section 36, a shelf section 38 and a means for reinforcement 40 of the shelf section 38 and the outer support section 14. The handle section 32 is connected to the shelf section 38 by the transition section 36. The shelf section 38 is substantially a sheet of material having a parabolic or arcuate shape with a flat portion 54 and a rounded portion 56. The shelf section 38 is received on the exterior portion 14b of the outer support section 14 of body 12 in a predetermined location such that the flat portion 54 of the shelf section 38 is facing toward the jaw, teeth and gingiva area of the patient's oral cavity and the rounded portion 56 of the shelf section 38 is facing a direction that is opposite of the flat portion 54 of the shelf section 38. The rounded portion 56 of the shelf section 38 is specifically located on the body 12 such that any pressure placed upon the rounded portion 56 of the shelf section 38 will transfer along the length of the shelf section 38 and onto the body 12 uniformly. The flat portion 56 of the shelf section 38 allows the dental technician or dental a place to pull down on the dental tray 10 with either their fingers or with a tool to remove the cured impression. This ensures that the impression is never damaged or distorted by the removal process because the pressure to remove the cured impression is transferred uniformly to the body 12. The means for reinforcement 40 of the shelf section 38 and the outer support section 14 is used to provide stability between the means for insertion and removal 30 of dental tray 10 and the body 12 when impression material is being onto the dental impression tray 10. In one embodiment of the present invention, the means for reinforcement 40 of the shelf section 38 and the outer support section 14 comprises a reinforcement section 42 that is connected to both the flat portion 54 of the shelf section 38 and the exterior portion 14b of the outer support section 14 of the body 12. The shelf section 38 is designed to distribute the pressure applied by the dentist or dental technician to the outer support section 14 uniformly onto the dental tray 10 to correctly seat the dental tray 10 and the impression material around the jaw, teeth and gingiva areas of the patient's oral cavity.

The handle section 32 is attached to the shelf section 38 by the transition section 36 at the anterior end 12a of body 12. The location and size of the handle in most prior art causes the handle to be a hindrance to obtaining an accurate impression as these handles: (1) force the operator to place their hand, wrist and arm in incorrect and uncomfortable positions while they place these dental trays and impression material into the mouth of the patient and while they are seating the dental impression tray and impression material in the patient's mouth during the process of obtaining the dental impression, which over time can injure the operator; (2) are so wide that the dental tray either traps or blocks the fingers of the operator when they attempt to seat the dental tray and impression material; (3) deforms the patient's lips which prevents the operator from obtaining an accurate impression and causes discomfort to the patient as it places pressure on the patient's lips; and (4) are not long enough to be used to by the operator to remove the dental tray and cured impression material which can lead to damaging or distorting the impression.

Ideally, the handle section 32 width dimension need to be narrow enough to fit between the fingers of the dentist or dental technician so that he/she can reach the bottom of the dental tray 10 to apply pressure to seat the dental tray 10 and impression materials, but wide enough to be used to insert and remove the dental tray 10 when it is retaining the impression material. The handle section 32 length dimension needs to be long enough to extend past the patient's lips when taking the impression so that it can be effectively used to insert and remove the dental tray 10 and impression material, but short enough to not be in the way of the dentist or dental technician when he/she is seating the dental tray 10 and the impression material. This allows the handle section 32 to be used to facilitate easy insertion and removed of the dental tray 10 and impression material from the patient's from the patient's oral cavity; allows the handle section 32 to be received between the fingers of the dentist or dental technician's hand comfortably to facilitate the operator being able to apply pressure to the shelf section 38 to seat the dental tray 10 and impression material while keeping their hand, wrist and arm in an ergonomically correct position; and allows the handle section 32 to line up with the patient's lips and extend past the patient's lips when taking the impression so that the handle section 32 does not deform the patient's lips which allows for an accurate impression to be obtained and reduces the discomfort of the patient.

A method of obtaining an impression with the improved dental tray contemplated by the embodiment of the present invention comprise the following steps: (1) selecting the proper sized new dental tray to be used to obtain the impression; (2) selecting impression material with desired curing properties to be used with the selected new dental tray; (3) applying the impression material to the peripheral of the dental tray; (4) placing the new dental tray, with the impression material retained by the new tray, in the patient's oral cavity with the means for insertion and removing of the tray; (5) having the dentist or dental technician hold the dental tray and impression material in position in the oral cavity which causes the impression material to flow through the plurality of openings in the body such that the impression material transfers to fill in any voids in order to create an impression of the patient's oral cavity while performing functional movements to further deform the uncured impression material; wherein the functional movements include at least one swallowing movement, at least one chewing movement, and at least one tongue movement; (6) holding the dental tray and impression materials in place until the impression material is cured; (7) removing the dental tray and cured impression materials from the patient's oral cavity with the means for insertion and removal of the tray to prevent damage of the impression; and (8) removing any nonessential impression material from the dental tray. The means for insertion and removal 30 of the dental tray 10 utilized in the foregoing method is fully discussed above.

Whereas, the present invention has been described in relation to the drawings attached hereto, it should be understood that other and further modifications, apart from those shown or suggested herein, may be made within the spirit and scope of this invention.

What is claimed is:

1. A dental impression tray used in cooperation with at least one impression material for obtaining an impression of a jaw, teeth and gingiva area in an oral cavity of a dentate or dental prosthesis patient, comprising:
a body having an anterior end, a posterior end, a plurality of body openings, an outer support section having an interior portion and an exterior portion, a central support section, and a channel section;
a shelf section comprising an arcuate sheet of material connected to said exterior portion of said outer support section such that any pressure placed upon said shelf section transfers uniformly along a length of said shelf section and onto said body;
a handle section connected to said shelf section by a transition section near said anterior portion of said body;
a border being substantially positioned along a terminal end of said outer support section;
wherein said outer support section is connected to said central support section by said channel section; and
wherein said outer support section extends generally perpendicularly from said channel section.

2. The dental impression tray of claim 1 further comprising a reinforcement mechanism providing stability between said shelf section and said outer support section.

3. The dental impression tray of claim 2 wherein said shelf section comprises a flat portion and a rounded portion.

4. The dental impression tray of claim 3 wherein said reinforcement mechanism is connected to said flat portion of said shelf section and said exterior portion of said outer support section of said body.

5. The dental impression tray of claim 1 wherein said border is substantially annular in shape having a plurality of border channels.

6. The dental impression tray of claim 5 wherein said border channels comprise substantially V-shaped cuts or notches.

7. The dental impression tray of claim 1 wherein said central support section comprises an upwardly contoured palatal ledge spanning said outer support section.

8. The dental impression tray of claim 1 wherein said central support section includes a substantially curved end near said posterior end of said body for capturing said patient's hard/soft throat palate and Mylohyoid space.

9. The dental impression tray of claim 1 wherein said body opening comprise a plurality of substantially dumbbell-shaped body openings and a plurality of substantially annular-shaped body openings.

10. The dental impression tray of claim 1 wherein said body openings comprise a variety of sizes and orientations.

11. The dental impression tray of claim 1 wherein said body openings are positioned on said body at predetermined locations such that the combination of size, shape and location of said body openings cooperate with said body to allow said impression material to vent through said body openings and to return said impression materials on said body.

12. The dental impression tray of claim 1 wherein said dental impression tray is constructed of a metal, a metal plated with a second material, or non-metal material.

13. The dental impression tray of claim 12 wherein said second material is chrome, stainless steel, a polymer or a resin.

14. The dental impression tray of claim 12 wherein said non-metal material is a thermoplastic polymer or a resin.

15. The dental impression tray of claim 14 wherein said thermoplastic polymer is polystyrene.

16. The dental impression tray of claim 1 wherein said impression material has a density range from extra light to very heavy.

17. A method of obtaining an impression of a jaw, teeth and gingiva area in an oral cavity of a dentate or dental prosthesis patient, comprising the steps of:
(1) selecting properly sized dental impression tray to be used to obtain said impression;
(2) selecting an impression material with desired curing properties to be used with said dental impression tray;
(3) applying said impression material to a periphery of said dental impression tray;
(4) placing said impression tray, with said impression material, in said patient's oral cavity with a means for insertion and removal of said dental impression tray; wherein said means for insertion and removal of said dental impression tray comprises:
i. a shelf section connected to an exterior portion of said dental impression tray; said shelf section comprising an arcuate sheet material;
ii. a handle section connected to said shelf section by a transition section;
iii. a reinforcement mechanism providing stability between said shelf section and said dental impression tray; wherein said reinforcement mechanism is connected to said shelf section and said exterior portion of said dental impression tray; and
iv. wherein said shelf section is connected to said dental impression tray such that any pressure placed upon said shelf section transfers uniformly along a length of said shelf section and onto said dental impression tray;
(5) having a dentist or dental technician hold said dental impression tray and said impression material in place to deform uncured impression material, which causes said impression material to flow through a plurality of body openings such that said impression material transfers to fill in any voids in order to create said impression of said patient's oral cavity;
(6) holding said dental impression tray and said impression material in place while performing functional movements to further deform uncured impression material;
(7) removing said dental impression tray and cured impression materials from said patient's oral cavity with said means for inserting and removing of said dental impression tray to prevent damage of said impression; and
(8) removing any nonessential impression material from said dental impression tray.

18. The method of obtaining an impression of claim 17 wherein said functional movements include at least one swallowing movement, at least one chewing movement, and at least one tongue movement.

19. The method of obtaining an impression of claim 17 wherein said means for insertion and removal of said dental impression tray further comprises a border being substantially annular in shape and substantially positioned along a terminal end of said exterior portion of said dental tray.

20. The method of obtaining an impression of claim 17 further comprising reshaping of said dental impression tray to specifically accommodate said patient's oral cavity.

21. The method of obtaining an impression of claim 20 wherein said reshaped of said dental impression is accomplished by heating and remolding said dental impression tray, wherein said heating is accomplished with an external heating source.

22. The method of obtaining an impression of claim 20 wherein said reshaping of said dental impression is accomplished by trimming of said dental impression tray, wherein said trimming is accomplished by an external cutter.

23. The method of obtaining an impression of claim 17 wherein said body openings comprise a plurality of substantially dumbbell-shaped body openings and a plurality of substantially annular-shaped body openings positioned on said body at predetermined locations allowing said impression material to vent through said body openings and to retain said impression material on said body.
